(19) United States
(12) Patent Application Publication
(10) Pub. No.: US 2026/0148376 A1
(43) Pub. Date: May 28, 2026

(54) DEVICE AND METHOD OF USING DEEP LEARNING MODEL TO RE-INSPECT PRINTED CIRCUIT BOARD WITH DEFECTIVE SOLDER PASTE

(71) Applicants: SQ Technology (Shanghai) Corporation, Shanghai (CN); Inventec Corporation, Taipei City (TW)

(72) Inventor: Shu-Jian Liu, Shanghai (CN)

(21) Appl. No.: 19/025,449

(22) Filed: Jan. 16, 2025

(30) Foreign Application Priority Data
Nov. 27, 2024 (CN) 2024117211253

(51) Int. Cl. G06T 7/00; G06V 10/764

(52) U.S. Cl. CPC G06T 7/0012; G06V 10/764; G06T 2207/30148

(57) ABSTRACT

Systems and methods using a deep learning model to re-inspect a printed circuit board with defective solder paste and a method are disclosed. A printed solder paste image of a printed circuit board determined as defective solder paste printing by an automated optical inspection apparatus is obtained. A classification model classifies the printed solder paste image. When the classification model classifies image features of the printed solder paste image corresponding to a soldering point area on the printed circuit board as good solder paste printing, a soldering point window image corresponding to the soldering point area is extracted from the printed solder paste image. The classification model determines whether the soldering point window image indicates that the solder paste in the corresponding soldering point area is well-printed.

### CROSS-REFERENCE TO RELATED APPLICATION

This application claims the benefit of Chinese Application Serial No. 2024117211253, filed Nov. 27, 2024, which is hereby incorporated herein by reference in its entirety.

### BACKGROUND OF THE INVENTION

### 1. Field of the Invention

The present invention relates to a defective solder paste printing circuit board re-inspecting device and a method thereof particular to a device of using a deep learning model to re-inspect a printed circuit board with defective solder paste and method.

### 2. Description of the Related Art

An automated optical inspection (AOI) system is a high-speed and high-precision optical image inspection system in which machine vision is used as a standard inspection technique to solve the drawbacks of conventional manual inspection using optical instruments. The applications of AOI include research and development (R&D) in high-tech industries, manufacturing quality control, and fields such as defense, public services, healthcare, environmental protection, and electricity. The AOI, as a representative method in industrial processes, uses optical instruments to obtain surface conditions of products and then employs computer image processing technology to detect defects such as foreign objects or abnormal patterns. Because of being a non-contact inspection technology, the AOI can be used for inspecting semi-finished products during intermediate processes.

In the printed circuit board (PCB) manufacturing industry, most defective products result from defective solder paste printing. Therefore, a solder paste inspection (SPI) device is commonly used to perform AOI technology on printed circuit board to check flatness, thickness, and offset of the solder paste on printed circuit board, thereby identifying defective printed circuit boards caused by defective solder paste printing before components are mounted.

However, due to the numerous parameters used in a solder paste inspection (SPI) device, the parameter settings of solder paste inspection device may not be suitable for the inspection environment of printed circuit board, and it leads to a higher rate of misjudgment by the solder paste inspection device regarding solder paste printing condition of the printed circuit board, resulting in a low first pass yield (FPY). To improve the FPY of the solder paste inspection device inspecting printed circuit board, technical personnel must continuously learn and adjust the parameters of different solder paste inspection device, it leads to significant maintenance costs.

According to above-mentioned contents, what is needed is to develop an improved solution to solve the problem that significant time and maintenance costs are required for technical personnel to maintain SPI device to improve the FPY of the solder paste inspection device.

### SUMMARY OF THE INVENTION

An objective of the present invention is to disclose a device of using a deep learning model to re-inspect a printed circuit board with defective solder paste and a method thereof, to solve the problem that significant time and maintenance costs are required for technical personnel to maintain solder paste inspection (SPI) device to improve the FPY of the solder paste inspection device.

To achieve the objective, the present invention discloses a device that uses a deep learning model to re-inspect a printed circuit board with defective solder paste. The device includes an image obtaining module, a printing classification module, an image cropping module and an area determining module. The image obtaining module is configured to obtain a printed solder paste image of a printed circuit board, wherein the printed circuit board is determined as defective solder paste printing by an automated optical inspection (AOI) apparatus. The printing classification module is configured to use a classification model to classify the printed solder paste image, wherein the classification model is a deep learning model. When the classification model classifies image features of the printed solder paste images corresponding to soldering point areas on the printed circuit board as good solder paste printing, the image cropping module extracts soldering point window images corresponding to the soldering point areas from the printed solder paste image. The area determining module is configured to use the classification model to determine whether each of soldering point window images indicates that a corresponding one of the soldering point areas can be classified as having good solder paste printing.

To achieve the objective, the present invention discloses a method of using a deep learning model to re-inspect a printed circuit board with defective solder paste, the method includes steps of: obtaining a printed solder paste image of a printed circuit board, wherein the printed circuit board is determined as defective solder paste printing by an automated optical inspection (AOI) apparatus; using a classification model to classify the printed solder paste image, wherein the classification model is a deep learning model; when the classification model classifies image features of the printed solder paste image corresponding to one or more soldering point areas on the printed circuit board as good solder paste printing, extracting a soldering point window image corresponding to the soldering point area from the printed solder paste image and using the classification model to determine whether the soldering point window image indicates that one or more of the soldering point areas can be classified as having good solder paste printing.

According to the device and method of the present invention, the difference between the present invention and the conventional technology is that, in the present invention, after the printed solder paste image of the printed circuit board to be determined as defective solder paste printing by the automated optical inspection (AOI) apparatus is obtained, the classification model can classify the printed solder paste image. When the classification model classifies the image features of the printed solder paste image corresponding to soldering point areas on the printed circuit board as good solder paste printing, one or more soldering point window images corresponding to the soldering point areas are extracted from the printed solder paste image. The classification model then determines whether the soldering point window images indicate that the solder paste in corresponding soldering point area is well printed, thereby reducing the maintenance cost for technical personnel on SPI devices, and achieving the technical effect of lowering the misjudgment rate of solder paste printing conditions for printed circuit boards . . .

### BRIEF DESCRIPTION OF THE DRAWINGS

The structure, operating principle and effects of the present invention will be described in detail by way of various embodiments which are illustrated in the accompanying drawings.

FIG. 1 is a schematic view of a device of using a deep learning model to re-inspect a printed circuit board with defective solder paste, according to the present invention.

FIG. 2 is a schematic view of a processor, according to the present invention.

FIG. 3A is a flowchart of a method of using a deep learning model to re-inspect a printed circuit board with defective solder paste, according to the present invention.

FIG. 3B is a flowchart of training a deep learning model, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

The concept of present invention is to obtain a printed solder paste image of a printed circuit board identified as defective solder paste printing by a SPI device, use a deep learning model to recognize a solder paste printing condition of a soldering point window image (in the whole printed solder paste image) corresponding to a soldering point area of the printed circuit board, thereby re-inspecting the printed circuit board identified as defective solder paste printing by the solder paste inspection device.

The device for implementing the concept of the present invention can be a computing apparatus. The computing apparatus mentioned in the present invention can include, but not limited to, one or more processing module, one or more memory module, and a bus connected to different hardware components including the memory module and the processing module. Through the hardware components, the computing apparatus can load and execute the operating system, so that the operating system runs on the computing apparatus and executes software or programs. In addition, the computing apparatus can include an outer shell, and the above-mentioned hardware component are disposed in the outer shell.

The bus mentioned in the present invention can include at least one type of bus, for example, the bus can include at least one of a data bus, an address bus, a control bus, an expansion bus, and a local bus. The bus of a computation device can include, but not limited to, a parallel bus such as an industry standard architecture (ISA) bus, a peripheral component interconnect (PCI) bus, a video electronics standards association (VESA) local bus, or a serial bus such as a USB, or a PCI express (PCI-E/PCIe) bus.

The processing module of the computing apparatus is coupled with the bus. The processing module includes a register group or a register space. The register group or the register space can be completely set on the processing chip of the processing module, or can be all or partially set outside the processing chip and is coupled to the processing chip through dedicated electrical connection and/or a bus. The processing module can be a central processing unit, a microprocessor, or any suitable processing component. If the computing apparatus is a multi-processor apparatus, that is, the computing apparatus includes processing modules, and the processing modules can be all the same or similar, and coupled and communicated with each other through a bus. The processing module can interpret a computer instruction or a series of multiple computer instructions to perform specific operations or operations, such as mathematical operations, logical operations, data comparison, data copy/moving, so as to drive other hardware component, execute the operating system, or execute various programs and/or module in the computing apparatus. The computer instructions can include assembly language instructions, instruction set architecture instructions, machine instructions, machine-related instructions, microinstructions, firmware instructions, or source code or object code written in one or more programming languages. The instructions can be executed entirely on a single computing apparatus, partially on a single computing apparatus, or partially on one computing apparatus and partially on another interconnected computing apparatus. The above-mentioned programming language can be, for example, object-oriented languages such as Common Lisp, Python, C++, Objective-C, Smalltalk, Delphi, Java, Swift, C#, Perl, Ruby, as well as procedural languages like C or similar languages.

The computing apparatus usually also includes one or more chipsets. The processing module of the computing apparatus can be coupled to the chipset, or electrically connected to the chipset through the bus. The chipset includes one or more integrated circuits (IC) including a memory controller and a peripheral input/output (I/O) controller, that is, the memory controller and the peripheral input/output controller can be implemented by one integrated circuit or implemented by two or more integrated circuits. Chipsets usually provide I/O and memory management functions, and multiple general-purpose and/or dedicated-purpose registers, timers. The above-mentioned general-purpose and/or dedicated-purpose registers and timers can be coupled to or electrically connected to one or more processing modules to the chipset for being accessed or used. In an embodiment, the chipset can be a part of the processing module.

The processing module of the computing apparatus can also access the data stored in the memory module and mass storage area installed on the computing apparatus through the memory controller. The above-mentioned memory modules include any type of volatile memory and/or non-volatile memory (NVRAM), such as Static Random Access Memory (SRAM), Dynamic Random Access Memory (DRAM), Read-Only Memory (ROM), or Flash memory. The above-mentioned mass storage area can include any type of storage device or storage medium, such as hard disk drives, optical discs, flash drives, memory cards, and solid state disks (SSD), or any other storage device. In other words, the memory controller can access data stored in static random access memory, dynamic random access memory, flash memory, hard disk drives, and solid state drives.

The processing module of the computing apparatus can also connect and communicate with peripheral devices and interfaces including peripheral output devices, peripheral input devices, communication interfaces, or data/signal receivers through the peripheral I/O controller and the peripheral I/O bus. The peripheral input device can be any type of input device, such as a keyboard, mouse, trackball, touchpad, or joystick. The peripheral output device can be any type of output device, such as a display, or a printer; the peripheral input device and the peripheral output device can also be the same device such as a touch screen. The communication interface can include a wireless communication interface and/or a wired communication interface. The wireless communication interface can include the interface capable of supporting wireless local area networks (such as Wi-Fi, Zigbee, etc.), Bluetooth, infrared, and near-field communication (NFC), 3G/4G/5G and other mobile communication network (cellular network) or other wireless data transmission protocol; the wired communication interface can be an Ethernet device, a DSL modem, a cable modem, an asynchronous transfer mode (ATM) devices, or optical fiber communication interfaces and/or components. The data/signal receiver can include a GPS receiver or physiological signal receiver. The physiological signals received by the physiological signal receiver include, but are not limited to, heartbeat, blood oxygen levels, and so on. The processing module can periodically poll various peripheral devices and interfaces, so that the computing apparatus can input and output data through various peripheral devices and interfaces, and can also communicate with another computing apparatus having the above-mentioned hardware components.

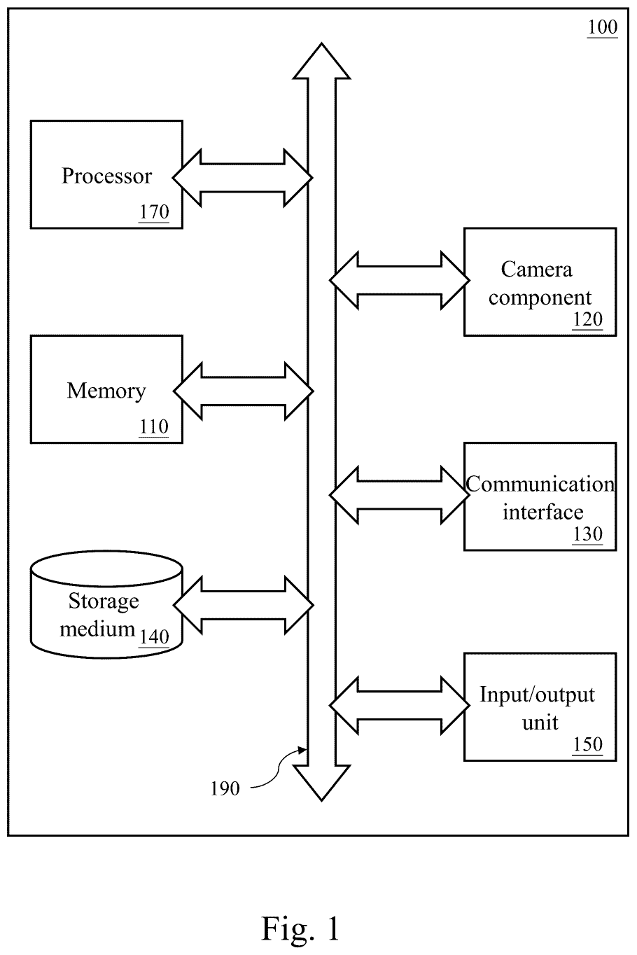

The device for implementing the present invention will be illustrated in the following paragraphs with reference to FIG. 1. FIG. 1 is a schematic view of components of a device of using a deep learning model to re-inspect a printed circuit board with defective solder paste disclosed in the present invention. As shown in FIG. 1, a device 100 of the present invention includes a memory 110, a camera component 120, a communication interface 130, a storage medium 140, a processor 170, and a bus 190. The memory 110, the communication interface 130, the storage medium 140, and the processor 170 are interconnected via the bus 190.

The memory 110 stores one or more sets of computer instructions.

The camera component 120 includes a circuit board, a camera assembly, and an image sensing unit (not shown in FIG. 1). The camera assembly and image sensing unit are connected through the circuit board. The camera component 120 captures images through the camera assembly and the image sensing unit.

The communication interface 130 is connected to a network device (such as an external network storage device or a server) and requests the connected network device for downloading data.

The storage medium 140 stores data or signals downloaded by the communication interface 130, stores data or signals required for operation of the processor 170 operation, or stores data or signals generated by the processor 170.

The input/output unit 150 provides input data through a peripheral input device of the device 100. For example, the input/output unit 150 can input data via a keyboard, a mouse, a touchpad, or a touchscreen.

The input/output unit 150 outputs data generated by the processor 170 through a peripheral output device of the device 100. For example, the input/output unit 150 can display data on a display or a touchscreen.

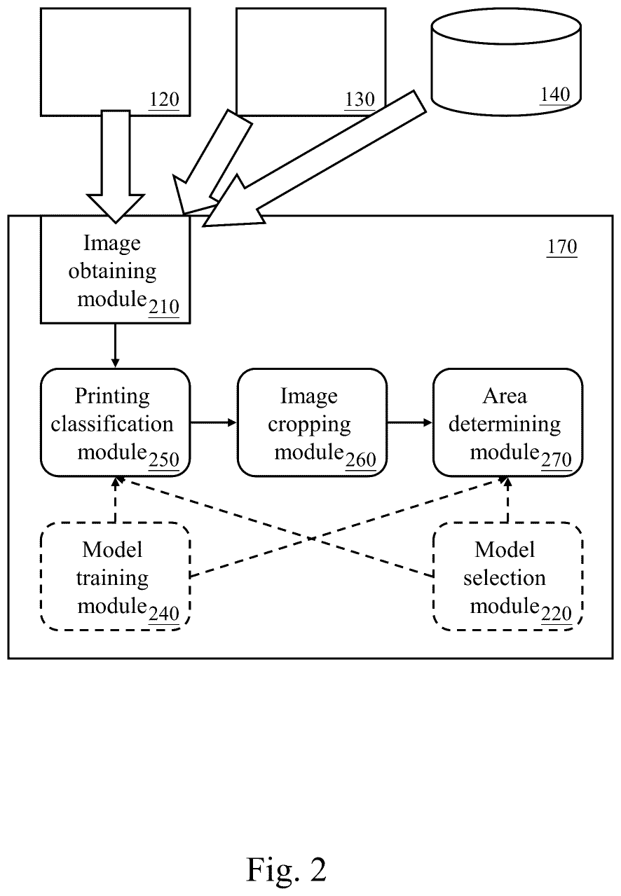

As shown in FIG. 2, the processor 170 includes an image obtaining module 210, a printing classification module 250, an image cropping module 260, and an area determining module 270. Optionally, the processor 170 may also include a model selection module 220 and a model training module 240. In an embodiment, the processor 170 executes the computer instructions stored in the memory 110 to generate the modules shown in FIG. 2 after executing the instructions. In another embodiment, the modules in FIG. 2 can be generated by one or more circuits and/or fully or partially integrated chip hardware components; that is, the processor 170 includes hardware components forming the modules shown in FIG. 2. In other words, the above-mentioned modules within the processor 170 can be software modules or hardware modules, and there are no specific limitations for the implementation of the modules in the present invention.

The image obtaining module 210 obtains a printed solder paste image of a printed circuit board, which is identified as defective solder paste printing by an automated optical inspection (AOI) apparatus (such as a solder paste inspection device). The printed solder paste image obtained by the image obtaining module 210 includes the entire image of the printed circuit board identified as defective solder paste printing; that is, the image of whole printed circuit board identified as defective solder paste printing. The printed solder paste image corresponds to the printed circuit board contained therein.

The image obtaining module 210 is connected to the automated optical inspection (AOI) apparatus or a network device (not shown in FIG. 2) through the communication interface 130 to obtain the printed solder paste image. Alternatively, the image obtaining module 210 may also capture the printed solder paste image of the printed circuit board identified as defective solder paste printing through the camera component 120, or read the printed solder paste image from the storage medium 140. There is no specific limitations in the manner of obtaining the printed solder paste image in the present invention.

The model selection module 220 selects a classification model through one or more feature heatmaps. The complexity of features in the printed solder paste image causes diverse feature categories, and the printed solder paste image possibly includes noise from soldering pads and the printed circuit board, so the model selection module 220 calculates influences (gradients) on the image features within solder paste areas of the printed solder paste image caused by the prediction results of various deep learning models for the solder paste areas of the printed solder paste image (that is, the soldering point areas of the printed circuit board corresponding to the printed solder paste image). Based on calculated influences, the model selection module 220 can select the most accurate deep learning model (i.e., a deep learning model with the greatest influence) for recognizing the image features in the solder paste areas of the printed solder paste image as the classification model. The deep learning model mentioned above is usually a convolutional neural network (CNN) model or includes a CNN model. The CNN model can include a convolution layer, a pooling layer, a flatten layer, and a fully connected layer (called FC layer, or dense layer). The convolution layer performs sliding convolution operations on the printed solder paste image to extract features such as edges, corners, and textures to generate various sizes of pixel matrices, known as feature maps. The pooling layer performs global average pooling (GAP) on the last feature map (i.e., the output map) to calculate the average of each channel, thereby reducing the spatial dimensions of the feature maps. The flatten layer converts (flattens) the feature map with reduced spatial dimensions into a one-dimensional feature vector, thereby retaining global information of each channel while spatial dimensions thereof are reduced to one dimension. These feature vectors are then provided to the fully connected layer, which normalizes the feature vector generated by the flatten layer into the dimensionality of the classification quantity (i.e., the flatten layer maps the feature vectors to all classifications), performs weighted calculations on each feature mapping, and adjusts the calculation results using normalization exponential functions like Softmax, thus, to generate class scores mapped to each classification defined by the CNN model (the class scores are prediction probabilities for each classification). The classification with the highest score (argmax) is taken as the prediction result.

For example, the model selection module 220 can use deep learning models to respectively recognize image features of different feature categories in the printed solder paste image to generate the feature heatmaps corresponding to different feature categories, calculate matching degrees between the key areas indicated by the feature heatmaps and the solder paste areas of the printed solder paste image, and select one of the deep learning model with the highest matching degree for each feature category as the deep learning model for recognizing the image features of each feature category in the printed solder paste image, thereby enabling the area determining module 270 to use the selected deep learning model.

The model training module 240 trains the deep learning model selected by the model selection module 220. The model training module 240 uses two different training datasets to train the same classification model (deep learning model): one dataset contains printed solder paste images of entire printed circuit board, and another contains soldering point window images of soldering point areas, so that the classification model can classify the printed solder paste image of entire printed circuit board based on the training result for the printed solder paste image of entire printed circuit board, and the classification model also can classify the soldering point window image containing only soldering point area based on the training result for the soldering point window images of soldering point areas.

After the classification model generates feature vectors of the feature categories, the model training module 240 uses normalization exponential functions like Softmax to adjust the dimensions of the feature vectors so that a dimensional value of each feature vector can be in a range between 0 and 1 and a sum of all dimensional values of the feature vectors equals 1.

During training, the model training module 240 adjusts one or more parameters in the deep learning model to improve the accuracy of classifying the printed solder paste image and the soldering point window image. For example, the model training module 240 adjusts the number of convolutional networks and transformer networks in the classification model, or adjusts a batch size for a single training session of the classification model based on GPU resources, or continuously adjusts the training epoch of the classification model until the loss of the classification model stabilizes, or selects an optimizer of the classification model to control gradient descent, or continuously adjusts a learning rate of the classification model to control a convergence speed, or selects a learning rate scheduler of the classification model to minimize the gradient.

It is to be noted that when the number of training samples for the printed solder paste image is imbalanced (for example, most samples represent good printing condition while only a few samples represent poor printing condition), the model training module 240 can employ a loss function to supervise the learning process of the classification model to adjust the weights of different categories so that the classification model can place greater emphasis on features from underrepresented samples. During the training of the classification model, integrating loss function supervision can improve the accuracy of the classification model in classifying poor solder paste printing samples significantly. For example, the model training module 240 can use the loss function to calculate a loss value for the printed solder paste image classified as good solder paste printing and then decrease the weight for the loss value calculated by the loss function, use the loss function to calculate a loss value for the printed solder paste image classified as defective solder paste printing and then increase a weight for the loss value calculated by the loss function, and the model training module 240 then train the classification model using the printed solder paste images with the decreased or increased weights, for example, the model training module 240 can train the classification model using Focal Loss function (shown below) until the loss curve of the loss function converges:

$$FL ( p , y ) = - α {y ( 1 - p )}^{γ} log ( p ) - ( 1 - α ) ( 1 - y ) {p}^{γ} log ( 1 - p )$$

where, y indicates whether the current sample belongs to a specific category (1 for yes, 0 for no), p indicates the prediction probability for the current category; y is a hyperparameter used to reduce a weight of samples classified easily, and y is usually a constant value. α indicates the adjustment factor (weight) of the current category, and the model training module 240 can generate a based on the number of training samples, and a is inversely proportional to the number of training samples in each category.

The printing classification module 250 uses the classification model to classify the overall image feature (also called global features) of the printed solder paste image obtained by the image obtaining module 210. For example, the image feature of the printed solder paste image can be classified as good solder paste printing or defective solder paste printing based on the uniformity of solder paste printing, brightness distribution of the printed solder paste image, and contrast between the background and the solder paste area represented by the image feature. When the image feature is classified as defective solder paste printing, another image feature classification is performed on the image feature. In an embodiment, the classification model can first capture the global features of the printed solder paste image and then extracts local features corresponding to the soldering point area in the printed solder paste image, and then superimposes or fuses global and local features, thereby retaining global information while emphasizing abnormality in local areas to refine the image feature for classifying defective solder paste printing.

When the classification model used by the printing classification module 250 classifies the printed solder paste image from the image obtaining module 210 as good solder paste printing, the image cropping module 260 extracts the soldering point window images from the printed solder paste image. Each extracted soldering point window image corresponds to different soldering point area on the printed circuit board.

For example, the image cropping module 260 obtains location information of the soldering point area on the printed circuit board and extracts the corresponding soldering point window image from the printed solder paste image based on the obtained location information. The location information includes a location and a distribution range of the soldering point area relative to the printed circuit board. It is to be noted that, to avoid failure of extracting the appropriate soldering point window image for determining whether the solder paste printing is good due to imprecise location information of the soldering point area, the image cropping module 260 can extract the soldering point window image with a coverage range larger than the distribution range of the soldering point area, and the soldering point window image also includes other soldering point within a certain distance around the soldering point area, this facilitates subsequent determinations of whether the soldering point area contains foreign objects or whether there are solder-bridge defects between soldering point.

The area determining module 270 uses the classification model selected by the model selection module 220 to determine whether each soldering point window image extracted by the image cropping module 260 indicates the corresponding soldering point area as good solder paste printing. For example, the area determining module 270 can determine the solder paste printing condition of the soldering point area based on image features indicating whether obvious voids exist in the soldering point, excessive solder paste accumulation exists, and whether solder paste uniform cover around the soldering point.

When the classification model determines that each of the soldering point window image indicates the corresponding soldering point area as good solder paste printing, the area determining module 270 determines that the corresponding printed circuit board passes inspection. When the classification model determines that certain soldering point window image indicates the corresponding soldering point area as defective solder paste printing, the area determining module 270 determines that printed circuit board fails to pass the inspection and marks the soldering point area corresponding to the soldering point window image classified as defective solder paste printing. For example, the area determining module 270 can store the location information of the soldering point area corresponding to the soldering point window image on the printed circuit board into the storage medium 140 or display or print the location information via the input/output module 150; however, the present invention is not limited to above-mentioned examples.

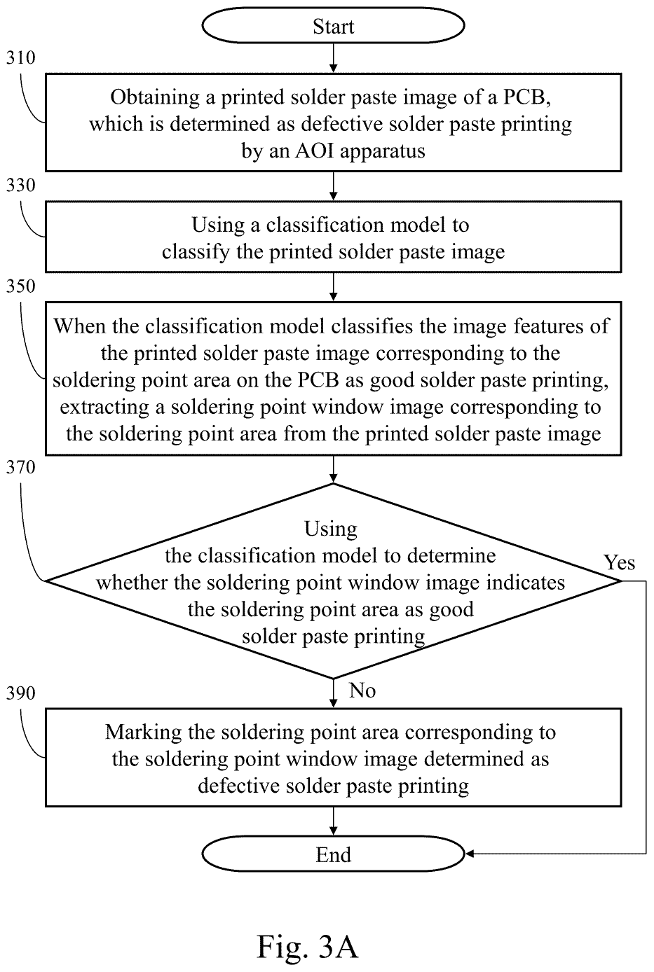

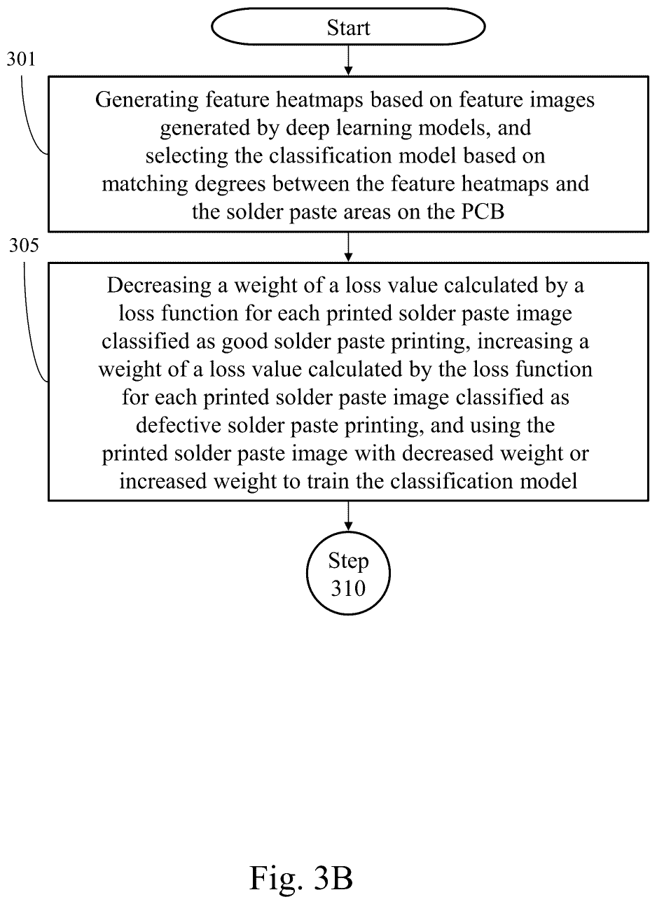

The operation of the system and method of the present invention will be explained through an embodiment, and please refer to FIG. 3A. FIG. 3A is a flowchart of a method of using a deep learning model to re-inspect a printed circuit board with defective solder paste according to the present invention. In this embodiment, the device 100 is a server operating on the production line of the printed circuit board and is located behind the solder paste inspection device, but the present invention is not limited to above-mentioned examples.

In a step 310, the image obtaining module 210 of the device 100 obtains a printed solder paste image of a printed circuit board classified as defective solder paste printing by an automated optical inspection apparatus. In this embodiment, the automated optical inspection apparatus is a solder paste inspection SPI) device, the image obtaining module 210 is connected to the solder paste inspection device or a specific network device on the production line through the communication interface 130 of the device 100 to download the printed solder paste image, or the image obtaining module 210 can capture the printed solder paste image of the printed circuit board classified as defective solder paste printing through the camera component 120 of the device 100.

In a step 330, after the image obtaining module 210 of the device 100 obtains the printed solder paste image, the printing classification module 250 of the device 100 uses a preselected classification model to classify the image feature of the printed solder paste image. In this embodiment, the preselected classification model can be a CoAtNet model including a convolution neural network (CNN) model and a transformer model. The transformer model dynamically assigns different attention weights to the elements in sequence based on another element information during the convolution operation of the CNN model, thereby enabling the CNN model to capture dependencies between elements at different positions. This allows the classification model to effectively identify relationships between the image features of whole printed solder paste image and the image features in a local soldering point area, so that the classification model can classify the image features of the printed solder paste image effectively. When the classification model classifies the printed solder paste image into the feature category of defective solder paste printing, the printed circuit board corresponding to the printed solder paste image that is the board under inspection currently is determined as defective solder paste printing and needs manual re-inspection.

In a step 350, when the classification model classifies the printed solder paste image obtained by the image obtaining module 210 of the device 100 into the feature category of good solder paste printing, the image cropping module 260 extracts the soldering point window images corresponding to different soldering point areas on the printed circuit board (that is, the printed circuit board to be inspected currently) from the printed solder paste image, respectively. In this embodiment, the image cropping module 260 obtains the original inspection information generated by the solder paste inspection device inspecting the printed circuit board through the communication interface 130 of the device 100, obtains the location information and the images of the soldering point areas on the printed circuit board, and the image cropping module 260 identifies the shapes and sizes of the soldering point areas in the images through image analysis techniques, additionally, defines window ranges of the soldering point areas based on the shapes and sizes of the soldering point areas, so that the window range includes other soldering point within a certain distance around the soldering point area, and the image cropping module 260 can extract the corresponding soldering point window image from the printed solder paste image based on the obtained location information and generated window range.

In a step 370, after the image cropping module 260 of the device 100 extracts the soldering point window image, the area determining module 270 of the device 100 uses the same classification model that classified the printed solder paste image to determine whether each of soldering point window images extracted by the image cropping module 260 of the device 100 indicates that the corresponding soldering point area can be classified as having good solder paste printing.

In a step 390, when the classification model determines that all soldering point window images extracted by the image cropping module 260 of the device 100 represent the corresponding soldering point areas as good solder paste printing, the area determining module 270 of the device 100 determines that the current printed circuit board passes the inspection, and when the classification model determines that at least one of the soldering point window images indicates the corresponding soldering point area as defective solder paste printing, the area determining module 270 determines that the current printed circuit board fails to pass the inspection, marks the soldering point area corresponding to the soldering point window image classified as defective solder paste printing, and this the soldering point area needs manual reinspection.

Thus, in the present invention, the classification model can perform two (whole and local) inspections on the printed solder paste image of the printed circuit board initially classified as defective solder paste printing by the automated optical inspection apparatus, thereby reducing the likelihood of misjudgment regarding the solder paste printing condition of the printed circuit board by the automated optical inspection apparatus.

In the above example, as shown in the flowchart of FIG. 3B, when the device 100 includes the model selection module 220 and the model training module 240, before the image obtaining module 210 of the device 100 obtains printed solder paste images of the printed circuit board classified as defective solder paste printing by the automated optical inspection apparatus (the step 310), in a step 301, the model selection module 220 generates feature heatmaps based on feature images generated by various deep learning models for the printed solder paste image, and selects the classification model based on matching degrees between the feature heatmaps and solder paste areas on the printed circuit board, so that the printing classification module 250 and the area determining module 270 of the device 100 can respectively use the same classification model selected by the model selection module 220 to classify whether the printed solder paste images to be good solder paste printing, and to determine whether each soldering point window image indicates the corresponding soldering point area as good solder paste printing (steps 330 and 370).

In a step 305, during the training of the classification model selected by the model selection module 220, the model training module 240 can decrease a weight of a loss value calculated by a loss function for each printed solder paste image classified as good solder paste printing, increase a weight of a loss value calculated by the loss function for each printed solder paste image classified as defective solder paste printing, and use the printed solder paste image with adjusted weights (decreased weight or increased weight) to train the classification model.

According to above-mentioned contents, the difference between the present invention and the conventional technology, in the present invention, after the printed solder paste image of the printed circuit board determined as defective solder paste printing by an automated optical inspection apparatus is obtained, the classification model classifies the printed solder paste image, when the classification model classifies image feature of the printed solder paste image corresponding to the soldering point area on the printed circuit board as good solder paste printing, the soldering point window image corresponding to the soldering point area is extracted from the printed solder paste image, the classification model determines whether the soldering point window image indicates that the solder paste in corresponding soldering point area is well printed. Therefore, the solution of the present invention can solve the problem the problem that significant time and maintenance costs are required for technical personnel to maintain SPI device to improve the FPY of the solder paste inspection device, to achieve the technical effect of lowering the misjudgment rate of solder paste printing conditions for printed circuit boards.

Furthermore, the method of using a deep learning model to re-inspect a printed circuit board with defective solder paste of the present invention can be implemented by hardware, software or a combination thereof, and can be implemented in a computer system by a centralization manner, or by a distribution manner of different components distributed in several interconnected computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of using a deep learning model to re-inspect a printed circuit board with defective solder paste, applied to a device or a system, and comprising:
obtaining a printed solder paste image of a printed circuit board, wherein the printed circuit board is determined as having defective solder paste printing, wherein the determining is performed by an automated optical inspection apparatus;
using a classification model to classify the printed solder paste image, wherein the classification model is a deep learning model;
when the classification model classifies a plurality of image features of the printed solder paste image corresponding to one or more soldering point areas on the printed circuit board as good solder paste printing, extracting a plurality of soldering point window images corresponding to each of the soldering point areas from the printed solder paste image; and
using the classification model to determine whether each of the soldering point window images indicates that one or more corresponding soldering point areas can be classified as having good solder paste printing.

2. The method of using a deep learning model to re-inspect a printed circuit board with defective solder paste according to claim 1, before the automated optical inspection apparatus inspects a solder paste printing condition of the printed circuit board, further comprising:
decreasing a weight of a loss value calculated by a loss function for the printed solder paste image classified as good solder paste printing, increasing a weight of a loss value calculated by the loss function for the printed solder paste image classified as defective solder paste printing, and training the classification model using the printed solder paste image with the decreased or increased weight.

3. The method of using a deep learning model to re-inspect a printed circuit board with defective solder paste according to claim 1, wherein after the step of using the classification model to determine whether each of the soldering point window images indicates the corresponding soldering point area as good solder paste printing, further comprises:
when the classification model determines that each of the soldering point window images indicates that one or more of the corresponding soldering point areas can be classified as good solder paste printing, determining that the printed circuit board passes the inspection; and
when the classification model determines that one of the soldering point window images indicates that one or more of the corresponding soldering point areas can be classified as as defective solder paste printing, determining that the printed circuit board fails to pass the inspection and marking the corresponding one of the soldering point areas corresponding to the soldering point window image determined as defective solder paste printing.

4. The method of using a deep learning model to re-inspect a printed circuit board with defective solder paste according to claim 1, wherein the step of obtaining the printed solder paste image of the printed circuit board, comprises:
connecting to the automated optical inspection apparatus to obtain the printed solder paste image, or capturing the printed solder paste image of the printed circuit board through a camera component of the device or the system.

5. The method of using a deep learning model to re-inspect a printed circuit board with defective solder paste according to claim 1, wherein before the automated optical inspection apparatus inspects the solder paste printing condition of the printed circuit board, further comprising:
selecting the classification model based on a matching degree between one or more feature heatmaps generated from a plurality of deep learning models recognizing one or more image features of the printed solder paste image and the solder paste areas on the printed circuit board, respectively.

6. A device of using a deep learning model to re-inspect a printed circuit board with defective solder paste, comprising:
a memory, configured to store at least one computer instruction; and
a processor, connected to the memory and configured to execute the at least one computer instruction to generate:
an image obtaining module, configured to obtain a printed solder paste image of a printed circuit board, wherein the printed circuit board is determined as defective solder paste printing by an automated optical inspection apparatus;
a printing classification module, configured to use a classification model to classify the printed solder paste image, wherein the classification model is a deep learning model;
an image cropping module, wherein when the classification model classifies a plurality of image features of the printed solder paste image corresponding to one or more soldering point areas on the printed circuit board as good solder paste printing, and wherein the image cropping module extracts a plurality of soldering point window images corresponding to each of the soldering point areas from the printed solder paste image; and
an area determining module, configured to use the classification model to determine whether each of soldering point window images indicates that one or more corresponding soldering point areas can be classified as having good solder paste printing.

7. The device of using a deep learning model to re-inspect a printed circuit board with defective solder paste according to claim 6, wherein the processor further generates a model training module configured to decrease a weight of a loss value calculated by a loss function for the printed solder paste image classified as good solder paste printing, increases a weight of a loss value calculated by the loss function for the printed solder paste image classified as defective solder paste printing, and trains the classification model using the printed solder paste image with the decreased or increased weight.

8. The device of using a deep learning model to re-inspect a printed circuit board with defective solder paste according to claim 6, wherein when the classification model determines that each of the soldering point window images indicates that one or more of the corresponding soldering point areas can be classified as having good solder paste printing, the area determining module determines that the printed circuit board passes the inspection, and when the classification model determines that one or more of the soldering point window images indicates that one or more of the corresponding soldering point areas can be classified as having defective solder paste printing, the area determining module determines that the printed circuit board fails to pass the inspection and marks the corresponding one of the soldering point areas corresponding to the soldering point window image determined as defective solder paste printing.

9. The device of using a deep learning model to re-inspect a printed circuit board with defective solder paste according to claim 6, wherein the image obtaining module is connected to the automated optical inspection apparatus to obtain the printed solder paste image or captures the printed solder paste image of the printed circuit board through a camera component of the device.

10. The device of using a deep learning model to re-inspect a printed circuit board with defective solder paste according to claim 6, wherein the processor further generates a model selection module configured to select the classification model based on a matching degree between one or more feature heatmaps generated from a plurality of deep learning models recognizing the image features of the printed solder paste image and the solder paste areas on the printed circuit board, respectively.
